(19) United States
(12) Patent Application Publication
(10) Pub. No.: US 2016/0057613 A1
(43) Pub. Date: Feb. 25, 2016

(54) MOVEMENT DETECTING BEACON

(71) Applicant: TELECOMMUNICATION SYSTEMS, INC., ANNAPOLIS, MD (US)

(72) Inventor: GORDON HINES, KIRKLAND, WA (US)

(21) Appl. No.: 14/523,529

(22) Filed: Oct. 24, 2014

Related U.S. Application Data
(60) Provisional application No. 62/041,483, filed on Aug. 25, 2014.

(51) Int. Cl. H04W 8/22; G01S 1/02; G01S 11/02

(52) U.S. Cl. CPC H04W 8/22; G01S 11/02; G01S 1/02

(57) ABSTRACT

A wireless beacon can be configured to operate in a stationary mode of operation. Profile data that uniquely identifies the wireless beacon can be broadcast in the stationary mode of operation. The wireless beacon can also be configured to detect that the wireless beacon has moved by a threshold displacement setting. The wireless beacon can further be configured to switch to a moving mode of operation in response to the detecting.

### CROSS-REFERENCE TO RELATED APPLICATION

This application claims the benefit of priority to U.S. Provisional Application No. 62/041,483, filed on Aug. 25, 2014, and entitled MOTION SENSING BLUETOOTH BEACON, the entirety of which is herein incorporated by reference.

### TECHNICAL FIELD

This disclosure relates to a wireless beacon.

### BACKGROUND

Bluetooth is a wireless technology standard for exchanging data over relatively short distances using short-wavelength ultra-high frequency (UHF) radio waves in a band from 2.4 to 2.485 GHz from fixed and mobile devices, and building personal area networks (PANs). Bluetooth can be employed to connect and synchronize several devices.

Bluetooth low energy (BLE), sometimes referred to a as Bluetooth Smart, is a wireless personal area network technology for novel applications in the healthcare, fitness, security, and home entertainment industries. Compared to Classic Bluetooth, BLE is intended to provide considerably reduced power consumption and cost while maintaining a similar communication range. In many cases, the low energy operational power requirement of BLE makes it possible to operate BLE enabled devices for more than a year without changing batteries or recharging.

### SUMMARY

One example relates to a wireless beacon that can be configured to operate in a stationary mode of operation, wherein profile data that uniquely identifies the wireless beacon is broadcast in the stationary mode of operation. The wireless beacon can also be configured to detect that the wireless beacon has moved by a threshold displacement setting. The wireless beacon can further be configured to switch to a moving mode of operation in response to the detecting.

Another example relates to a wireless beacon that can include a motion sensor configured to detect movement of the wireless beacon. The wireless beacon can also include a memory configured to store machine readable instructions. The wireless beacon can further include a processing unit configured to access the memory and execute the machine readable instructions. The machine readable instructions can include a beacon control configured to access profile data stored in the memory. The beacon control can also be configured to receive data from the motion sensor that characterizes the detected movements of the wireless beacon. The beacon control can further be configured to control broadcasting of a radio frequency (RF) signal that includes the profile data based on the data received from the motion sensor.

Yet another example relates to a method that can include broadcasting, by a wireless beacon, profile data that uniquely identifies the wireless beacon. The method can also include detecting, at the wireless beacon, that the wireless beacon is moving.

### BRIEF DESCRIPTION OF THE DRAWINGS

FIG. 1 illustrates an example of a system for implementing a wireless beacon that can detect movement.

FIG. 2 illustrates an example of a wireless beacon that can detect movement.

FIG. 3 illustrates an example of a facility with a beacon farm.

FIG. 4 illustrates an example of a flowchart of an example method for controlling a wireless beacon.

FIG. 5 illustrates another example of a flowchart of another method for controlling a wireless beacon.

### DETAILED DESCRIPTION

A wireless beacon can be provisioned with a beacon server at a given location. The wireless beacon can broadcast profile data via a radio frequency (RF) signal that uniquely identifies the wireless beacon at the given location. The wireless beacon can include a motion sensor, such as an accelerometer that can detect if the wireless beacon is moving. The wireless beacon can be configured to cease broadcasting or change the profile data in response to determining that the wireless beacon is moving. After moving the wireless beacon to another location (e.g., a desired or new location), the profile data can be re-broadcast or the changing of the profile data can be ceased. Moreover, the wireless beacon can be re-provisioned with the beacon server for the other location.

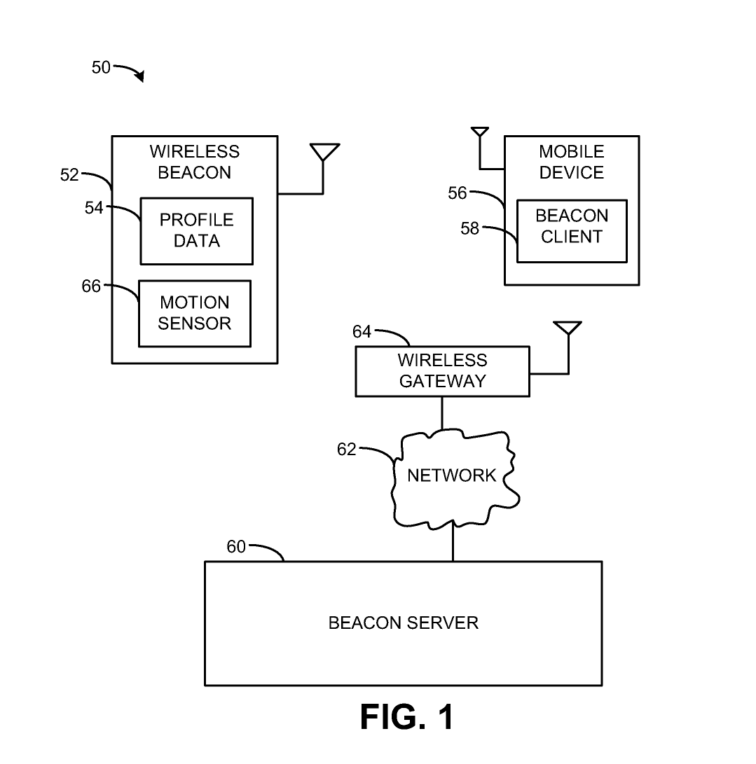

FIG. 1 illustrates an example of a system 50 that implements a wireless beacon 52. The wireless beacon 52 could be a peer-to-peer network location beacon. The wireless beacon 52 can be implemented, for example, as a computing device. For example, the wireless beacon 52 can be implemented as a Bluetooth Low Energy (BLE) beacon, a (classic) Bluetooth Beacon, a WiFi hotspot, etc. The wireless beacon 52 can be configured to continuously broadcast profile data 54 via an RF signal that can be received by nodes that are in relatively close physical proximity to the wireless beacon 52.

The profile data 54 can uniquely identify the wireless beacon 52. In some examples, the profile data 54 can be representative of multiple identifiers. For instance, if the wireless beacon 52 is implemented as a BLE beacon, the profile data 54 can include a universally unique identifier (UUID), a major code and a minor code. In many instances, the wireless beacon 52 can be a member of a set of wireless beacon 52 that can be referred to as a beacon “farm”.

A mobile device 56, such as a smart phone, a tablet computer or other end-user device can receive the profile data 54 from the wireless beacon 52. In some examples, the mobile device 56 can have a beacon client 58 (e.g., an application) executing thereon. The beacon client 58 can process the profile data 54 and provide the profile data 54 of the wireless beacon 52 to a beacon server 60. In some examples, the mobile device 56 can communicate with the beacon server 60 via a network 62. The network 62 can be implemented, for example, as a public network (e.g., the Internet), a private network (e.g., a carrier network) or a combination thereof. The mobile device 56 can communicate on the network 62 via a wireless gateway 64, which can be representative of a wireless router and/or wireless carrier system.

The beacon server 60 can resolve the wireless beacon 52 with a location. For instance, the beacon server 60 can employ the profile data 54 as an index that can indicate a physical location of the wireless beacon 52, and correspondingly, the mobile device 56. For example, the beacon farm can be employed in a multiple facility enterprise (e.g., an enterprise business) to facilitate the location of merchandise. In such a situation, the UUID of the wireless beach could, for example, be employed as an identifier of the business; the major code can identify the particular facility (retail establishment) that the wireless beacon 52 is located in. Moreover, the minor code could be employed as an identifier of a department or section in the particular facility. In such a situation, the beacon server 60 can, in some examples, provide the beacon client 58 with a uniform resource locator (e.g., web address or other address) that can be employed to access information about the area corresponding to the wireless beacon 52, such as an advertisement. Alternatively, the beacon server 60 can push the information to the beacon client 58.

For instance, in a given example (hereinafter, “the given example”), the wireless beacon farm can be employed in a hardware enterprise. In such a situation, each UUID of the profile data 56 in each wireless beacon 52 in the beacon farm can correspond to the name of the hardware enterprise. Moreover, each major code of the profile data 54 can represent a different facility (e.g., store), such that each wireless beacon 52 in the beacon farm within the same facility can have the same major code. Furthermore, each minor code of the profile data 54 can correspond to a particular area in the corresponding facility. In the given example, it is presumed that the facility is located in Seattle, Wash. and the minor code of the wireless beacon 52 indicates that the wireless beacon 52 is placed in the plumbing department in the facility. Thus, in the given example, the beacon server 60 can direct the beacon client 58 to a web page with advertisements, instructions or other information related to plumbing or push similar information to the beacon client 58. Additionally or alternatively, in the given example, the beacon server 60 can notify another entity (e.g., a computer) that the mobile device 56 is in the vicinity of the plumbing department, so that a sales associate can be dispatched to assist a user of the mobile device 56.

The wireless device can include a motion sensor 66 that can be implemented to include an accelerometer. The motion sensor 66 can detect, for example, that the wireless beacon 52 has been moved and/or is still moving. The wireless beacon 52 can be configured that upon moving a predetermine amount (e.g., about 3 meters), the wireless beacon 52 can be switch from a stationary mode of operation described herein, to a moving mode of operation. In the moving mode of operation, in some examples, the wireless beacon 52 can cease broadcasting of the profile data 54. In other examples, in the moving mode of operation, the wireless beacon 52 can change a portion of the profile data 54 (e.g., a proper subset), such as the minor code, which can be randomly, semi-randomly or systematically reassigned.

Upon positioning the wireless beacon 52 at a new location, a user of the wireless beacon 52 can re-provision (e.g., re-register) the wireless beacon 52 with the beacon server 60. In examples where the wireless beacon 52 ceases broadcasting the profile data 54, the wireless device can include an actuator (e.g., a button) that, upon actuation, causes the wireless beacon 52 to initiate (re)broadcasting the profile data 54. In examples where the portion of the profile data 54 changes in response to detecting movement, the wireless beacon 52 can be configured to cease changing the profile data 54, thereby stabilizing the entirety of the profile data 54 to a constant value.

To re-provision the wireless beacon 52, the mobile device 56 can be employed by a user moving the wireless device to the new location. In such a situation, upon positioning the wireless beacon 52 at the new location, the user of the mobile device 56 can employ the beacon client 58 to characterize the new location. The new location and the profile data 54 can be provided to the beacon server 60. New profile data 54 can be provided to the beacon server 60 if the profile data 54 is changed or the original profile data 54 can be provided to the beacon server 60 if the profile data 54 is unchanged. The beacon server 60 can re-provision the wireless beacon 52 at the new location such that other mobile devices can detect the wireless beacon 52 at the new location and be directed to the appropriate information (e.g., advertising) and/or assistance. By employing this system 50, the wireless beacon 52 can detect movement. Thus, if the wireless beacon 52 is moved inadvertently and the wireless beacon 52 is not re-provisioned, the beacon server 60 does not resolve to the original location of the beacon server 60.

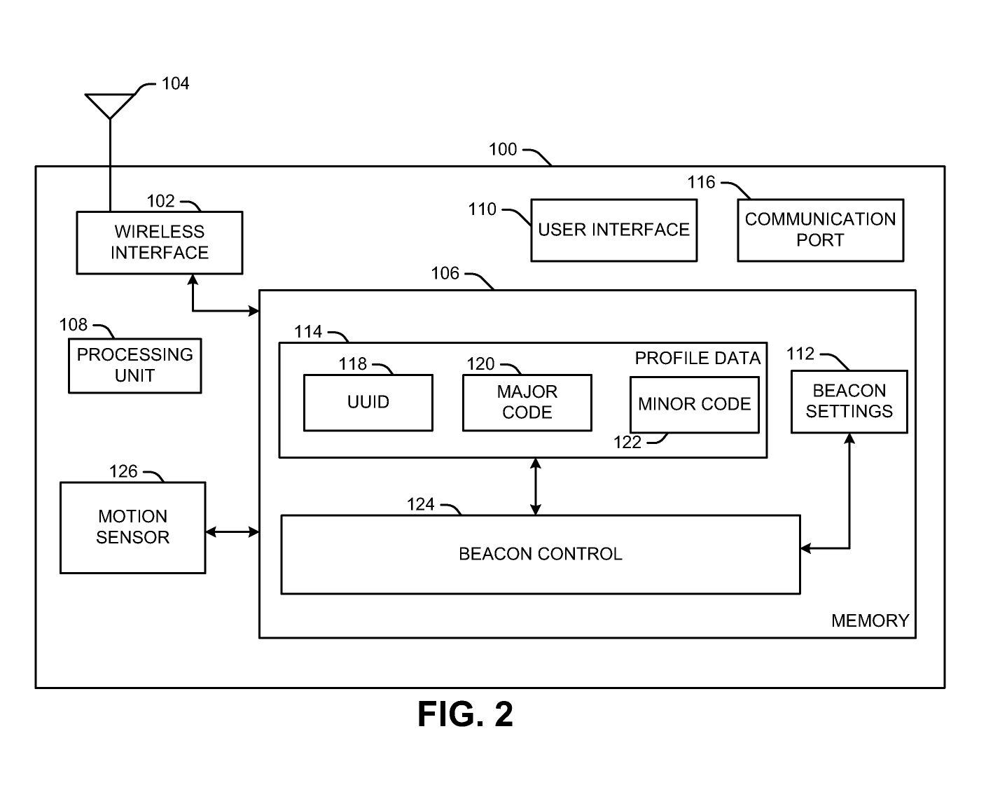

FIG. 2 illustrates an example of a wireless beacon 100 that could be employed, for example, to implement the wireless beacon 52 of FIG. 1. The wireless beacon 100 could be, for example, a peer-to-peer network protocol location beacon, such as a BLE beacon, a (classic) Bluetooth beacon, a WiFi hotspot configured as a beacon, etc. The wireless beacon 100 can include a wireless interface 102 coupled to an antenna 104. The antenna 104 can propagate and receive RF signals.

The wireless beacon 100 can include a memory 106 that can store machine readable instructions. The memory 106 can be a non-transitory machine readable medium. The memory 106 could be implemented, for example, as volatile memory 106 (e.g., random access memory), non-volatile memory such as flash memory, a solid state drive, a hard disk or a combination thereof. The wireless beacon 100 can also include a processing unit 108 that can access the memory 106 and execute the machine readable instructions. The processing unit 108 can include one or more processor cores. In some examples, the processing unit 108 and the memory 106 can be integrated together, such as in an application specific integrated circuit (ASIC) chip.

The wireless beacon 100 can include a user interface 110 that allows a user to control beacon settings 112 and/or profile data 114. In some examples, the user interface 110 could be implemented as a series of actuators (e.g., buttons, switches, dials, etc.). In other examples, the user interface 110 could be implemented as a graphical user interface (GUI), which GUI can include but is not limited to a touch pad. Additionally or alternatively, the wireless beacon 100 can include a communication port 116 (e.g., a universal serial bus (USB) port) that can allow an external device to control the beacon settings 112 and/or the profile data 114. In still other examples, the beacon settings 112 and/or the profile data 114 can be controlled wirelessly, such as through data traversing the wireless interface 102.

The beacon settings 112 can include, for example, an output power of the wireless beacon 100. The output power of the wireless beacon 100 can correspond to a distance from the wireless beacon 100 that another device can reliably communicate with the wireless beacon 100. In some examples, the output power can be adjusted such that at a minimum output power, the wireless beacon 100 can be detected by external devices that are up to about 0.3 meters (e.g., about 1 foot) away from the wireless beacon 100. Moreover, in a maximum output power, the wireless beacon 100 can be detected by external devices that are up to about 45 meters (150 feet) away from the wireless beacon 100. The beacon settings 112 can also include a maximum allowed displacement setting. The maximum allowed displacement setting can control a maximum displacement (movement) that is permitted by the wireless beacon 100 prior to the wireless beacon 100 changing operation modes.

The profile data 114 can be data that uniquely identifies the wireless beacon 100. In examples where the wireless beacon 100 is implemented as a BLE, the profile data 114 can include, for example, a UUID 118, a major code 120 and a minor code 122. In examples where the wireless beacon 100 is implemented as a different type of beacon, other types of data can additionally or alternatively be included in the profile data 114.

The memory 106 can include a beacon control 124 that can control operations of the wireless beacon 100. In particular, the beacon control 124 can cause the wireless beacon 100 to switch between a stationary mode of operation and a moving mode of operation in a manner described herein.

In the stationary mode of operation, the beacon control 124 can cause the wireless beacon 100 to broadcast the profile data 114 via the wireless interface 102 with a power defined in the beacon settings 112. In the stationary mode of operation, a mobile device (e.g., the mobile device 56 of FIG. 1) can receive the profile data 114 and contact a beacon server in the manner described to resolve a location of the mobile device and/or to disseminate information (e.g., an advertisement) to the mobile device.

The wireless beacon 100 can also include a motion sensor 126, such as an accelerometer. In such a situation, the motion sensor 126 can send measurement data to the beacon control 124 that can characterize detected acceleration by the wireless beacon 100. The beacon control 124 can process (e.g., doubly integrate) the measurement data to determine a displacement (e.g., movement) of the wireless beacon 100 based on the measurement data. The beacon control 124 can be configured to compare the determined displacement of the wireless beacon 100 with the maximum displacement of the beacon settings 112. The beacon control 124 can be configured such that if the detected displacement of the wireless beacon 100 exceeds the maximum displacement defined in the beacon settings 112, the beacon control 124 can cause the wireless beacon 100 to switch from the stationary mode of operation to the moving mode of operation.

The moving mode of operation can be implemented in a number of different ways. In one example, in response to being switched to the moving mode of operation, the beacon control 124 can cause the wireless beacon 100 to cease broadcasting the profile data 114. In such a situation, the beacon control 124 can continue to monitor measurement data from the motion sensor 126 to determine if the wireless beacon 100 is still in motion. For instance, if the motion sensor 126 includes an accelerometer, the beacon control 124 can detect when the acceleration of the wireless beacon 100 is below a threshold level, which can determine that the beacon is stationary. A user that is moving the wireless beacon 100 can employ the user interface 110 and/or the communication port 116 to indicate that the wireless beacon 100 is in a desired location (e.g., a new location) thereby causing the beacon control 124 to switch the wireless beacon 100 back to the stationary mode of operation. Moreover, in such a situation, the user can employ the mobile device to re-provision the wireless beacon 100 for the desired location (new location).

In another example, during the moving mode of operation, the beacon control 124 can cause the wireless beacon 100 to change a portion (or all) of the profile data 114. For instance, in one example, the beacon control 124 can randomly change the minor code 122 of the profile data 114 periodically. As used herein, the term “periodic” means to “reoccur based on change”, which change can include, but is not limited temporal change, spatial change, etc. Thus, in the moving mode of operation, a mobile device that receives the profile data 114 will detect continuously changing profile data 114 (e.g., the minor code). In other examples, other portions of the profile data 114, including the major code 120 and/or the UUID 118 could additionally or alternatively be randomly (or non-randomly) changed.

In situations where the presence of the wireless beacon 100 is detected by a mobile device while the wireless beacon 100 is still in the moving mode of operation, the beacon server can determine that the wireless beacon 100 is not provisioned. For instance, as noted the wireless beacon 100 can be configured such that only the minor code 122 of the profile data 114 changes and the UUID 118 and/or the major code 120 remains constant. In such a situation the beacon server can, in some examples, identify the wireless beacon 100 as a member of a beacon farm, and the beacon server can determine that the wireless beacon 100 is assigned to a specific facility. Additionally, the beacon server can determine that the wireless beacon 100 is not provisioned for any particular location within the specific facility.

The beacon control 124 can continuously monitor the measurement data of the motion sensor 126 (e.g., an accelerometer) to determine if the wireless beacon 100 has reached a stationary position, which can be at a desired location (e.g., a new location). Upon determining that the wireless beacon 100 has reached the stationary position, the beacon control 124 can cease randomly changing the profile data 114 (e.g., the minor code 122 of the profile data 114) and switch the wireless beacon 100 back to the stationary mode of operation. The user that moved the wireless beacon 100 (or another user) can employ a mobile device to re-provision the wireless beacon 100 with the desired location (e.g., the new location).

By employing the wireless beacon 100, users detecting the presence of the wireless beacon 100 can be assured that the wireless beacon 100 is positioned in a correct location. As explained, if the wireless beacon 100 is moved, the profile data 114 may not be broadcast or can be changed. In this manner, unexpected events such as accidental movements, theft, etc. of the wireless beacon 100 cause the wireless beacon 100 to switch to the moving mode of operation, such that the wireless beacon 100 would be prevented from having the beacon server resolve to an original (inaccurate) position.

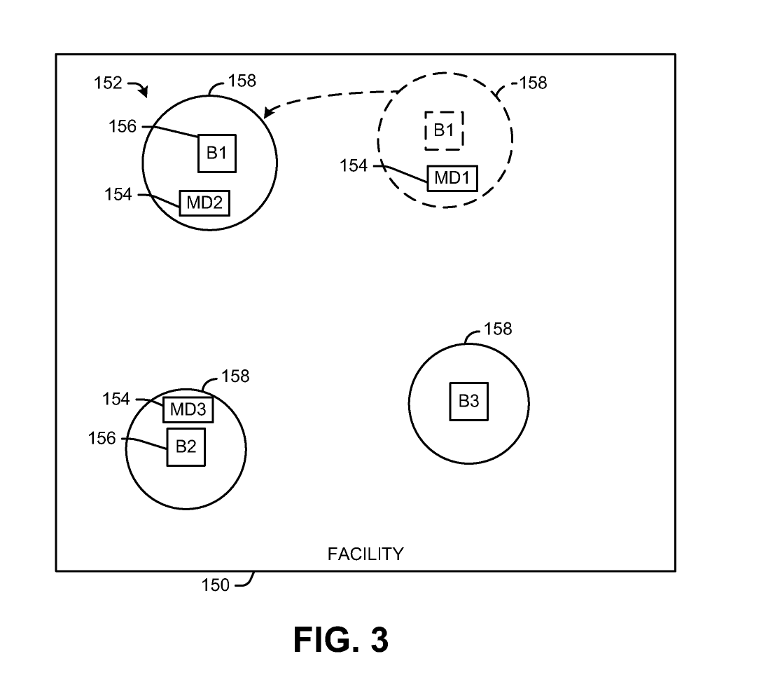

FIG. 3 illustrates an example of a facility 150 (e.g., a retail facility, a government facility, etc.) that implements a beacon farm 152 to facilitate identification of a location of mobile devices 154 within the facility 150. The beacon farm 152 illustrated in FIG. 3 includes three wireless beacons 156, labeled in FIG. 3 as “B1”, “B2” and “B3”. Each wireless beacon 156 can be implemented, for example, in a manner similar to the wireless beacon 52 of FIG. 1 and/or the wireless beacon 100 of FIG. 2. Moreover, the facility 150 includes three mobile devices, labeled in FIG. 3 as “MD1”, “MD2” and “MD3”. Each mobile device 154 can be implemented, for example, in a manner similar to the mobile device 56 illustrated in FIG. 1. It is to be understood that in other examples, more or less wireless beacons 156 and/or mobile devices 154 could be implemented.

Each wireless beacon 156 can broadcast profile data that can be received by a mobile device 154 when the mobile device 154 is within a boundary 158 corresponding to an output power of the wireless beacon 156. Moreover, in FIG. 3, wireless beacon B1 is depicted as being moved from an original location (noted by a dashed line) to a new location (e.g., a desired location), noted with a solid line. Thus, while the wireless beacon B1 is at the original location, the mobile device MD1 can detect the presence of the wireless beacon B1. Moreover, in this example, the wireless beacons B2 and B3 are substantially stationary, wherein the mobile device MD3 can detect wireless beacon B2 and no mobile device 154 detects the presence of the wireless beacon B3.

For purposes of simplification of explanation, it is presumed that the facility 150 represents a retail facility, and the wireless beacons B1, B2 and B3 are each placed in relatively close proximity to specific merchandise. In such a situation, when the wireless beacon B1 is in the original location, an advertisement can be provided to the mobile device MD1 and/or a sales associate can be dispatched to assist the user of the mobile device MD1.

Upon moving the wireless beacon B1 from the original location to the new location, the wireless beacon B1 can be switched from a stationary mode of operation to a moving mode of operation. In such a situation, in one example, broadcasting of profile data by the beacon B1 can be automatically disabled (e.g., ceased) until the wireless beacon B1 is stationary at the new location. At the new location, a user that moved the wireless beacon B1 can re-enable broadcasting of the profile data and re-provision the wireless beacon B1 with a beacon server thereby switching the wireless beacon B1 back to the stationary mode of operation. In another example, in the moving mode of operation, the profile data (or some portion thereof) can be periodically changed (e.g., reoccurring based on a change in time or space) randomly until the beacon B1 arrives at the new location, whereby the changing to the profile data ceases and the beacon B1 is switched back to the stationary mode of operation. Once at the new location, the user can re-provision the wireless beacon B1 with the beacon server.

Upon the wireless beacon B1 being re-provisioned, the mobile device MD2 can detect the presence of the wireless beacon B2 at the new location. In such a situation, the mobile device MD2 can resolve the wireless beacon B1 with the beacon server and the beacon server can take appropriate action. Such appropriate action can include, but is not limited to providing an advertisement for merchandise located near the new location to the mobile device MD2 and/or dispatching a sales associate to assist a user of the mobile device MD2.

By implementing the beacon farm 152 at the facility 150 in the manner described, it is possible to ensure that each wireless beacon 156 in the beacon farm 152 is correctly provisioned for the appropriate location. Thus, in instances where a wireless beacon 156 is moved inadvertently (e.g., by an accident or theft) a mobile device 154 detecting such a wireless beacon 156 prior to re-provisioning is not resolved to an inaccurate location.

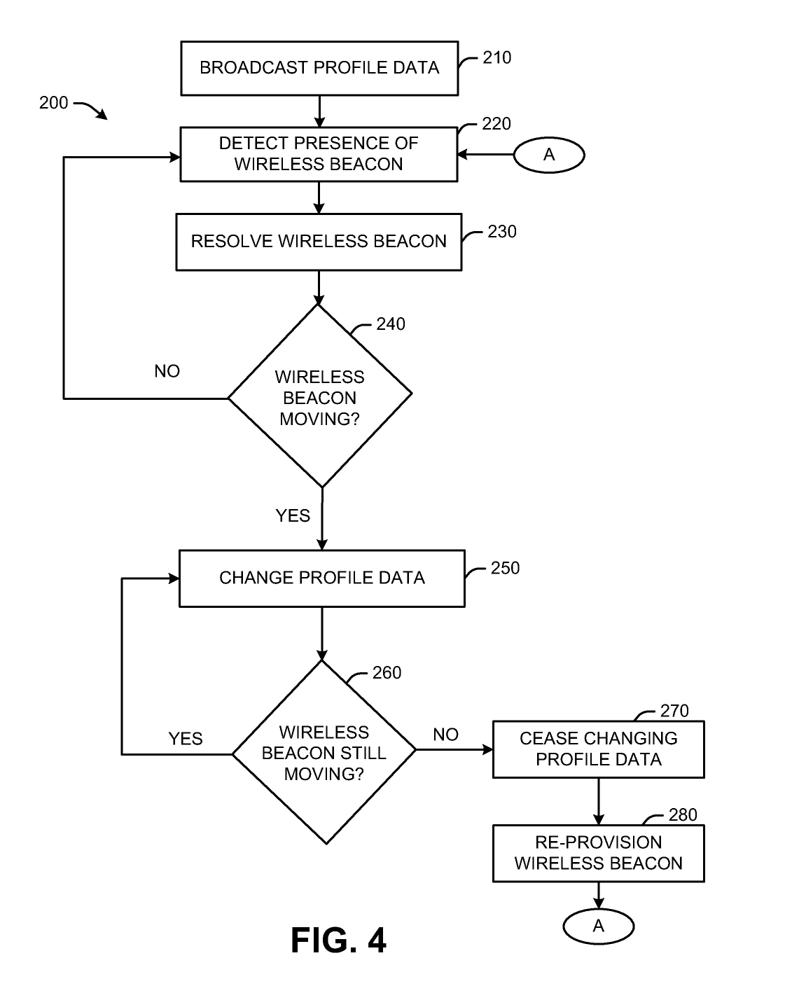

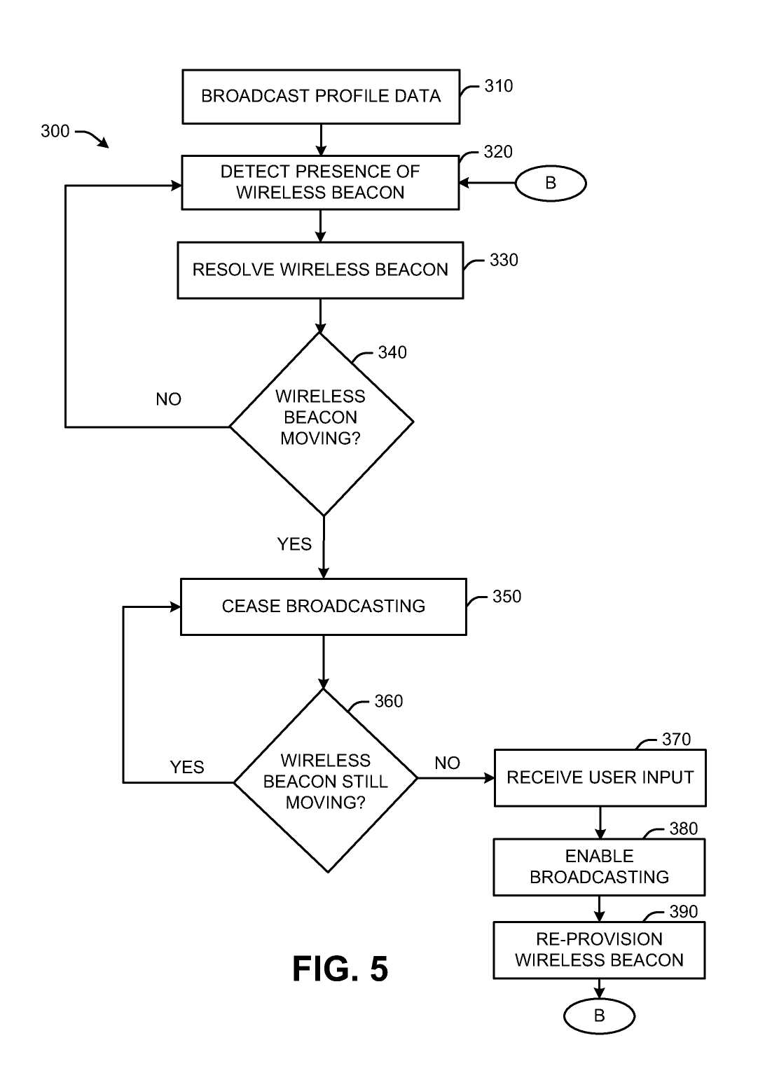

In view of the foregoing structural and functional features described above, example methods will be better appreciated with reference to FIGS. 4 and 5. While, for purposes of simplicity of explanation, the example methods of FIGS. 4 and 5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example methods of FIGS. 4 and 5 can be implemented as instructions stored in a non-transitory machine-readable medium. The instructions can be accessed by a processing resource (e.g., one or more processor cores) and executed to perform the methods disclosed herein.

FIG. 4 illustrates an example of a method 200 for moving a wireless beacon, such as the wireless beacon 52 illustrated in FIG. 1 and/or the wireless beacon 100 illustrated in FIG. 2. At 210, the wireless beacon can broadcast profile data via an RF signal. The wireless beacon can be provisioned (e.g., registered) with a beacon server for an original location. At 220, a mobile device (e.g., the mobile device 56 of FIG. 1) can detect the presence of the wireless beacon. Detection can include, for example, receiving profile data broadcast by the wireless beacon. At 230, the mobile device can resolve a location for the wireless beacon with the beacon server, such that the beacon server can take appropriate action based on the information that the mobile device is in relatively close proximity with the wireless beacon. Such actions can vary based on the environment in which the method 200 is implemented.

At 240, a determination can be made by a beacon control (e.g., the beacon control 124 of FIG. 2) of the wireless beacon as to whether the wireless beacon is moving. The determination at 240 can be based, for example, on measurement data provided by a motion sensor (e.g., the motion sensor 126 of FIG. 2) and beacon settings (e.g., the beacon settings 112 of FIG. 2). If the determination at 240 is negative (e.g., NO), the method can return to 220. If the determination at 240 is positive (e.g., YES), the method 200 can proceed to 250.

At 250, the profile data (or some portion thereof) can be changed by the beacon control. For example, if the wireless beacon is implemented as a BLE device, the minor code, a major code and/or a UUID of the profile data can be randomly (or systematically) changed by the beacon control. At 260, a determination can be made by the beacon control as to whether the wireless beacon is still moving. The determination at 260 can be based, for example on the measurement data provided from the motion sensor of the wireless beacon. If the determination at 260 is positive (e.g., YES), the method 200 can return to 250. If the determination at 260 is negative (e.g., NO), the method 200 can proceed to 270.

At 270, the beacon control can cease changing the profile data, such that the profile data can remain constant. At 280, a user can employ a mobile device to re-provision the wireless beacon with the wireless server to resolve at a new location to which the wireless device has been moved. The method 200 can return to 220.

FIG. 5 illustrates another example of a method 300 for moving a wireless beacon, such as the wireless beacon 52 illustrated in FIG. 1 and/or the wireless beacon 100 illustrated in FIG. 2. At 310, the wireless beacon can broadcast profile data via an RF signal. The wireless beacon can be provisioned (e.g., registered) with a beacon server for an original location. At 320, a mobile device (e.g., the mobile device 56 of FIG. 1) can detect the presence of the wireless beacon. Detection can include, for example, receiving profile data broadcast by the wireless beacon. At 330, the mobile device can resolve the wireless beacon with the beacon server, such that the beacon server can take appropriate action based on the information that the mobile device is in relatively close proximity with the wireless beacon. Such actions can vary based on the environment in which the method 300 is implemented.

At 340, a determination by a beacon control (e.g., the beacon control 124 of FIG. 2) of the wireless beacon can be made as to whether the wireless beacon is moving. The determination at 340 can be based, for example, on measurement data provided by a motion sensor (e.g., the motion sensor 126 of FIG. 2) and beacon settings (e.g., the beacon settings 112 of FIG. 2). If the determination at 340 is negative (e.g., NO), the method can return to 320. If the determination at 340 is positive (e.g., YES), the method 300 can proceed to 350.

At 350, the broadcasting of the profile data can be ceased (e.g., disabled) by the beacon control. At 360, a determination by the beacon control can be made as to whether the wireless beacon is still moving. The determination at 360 can be based on the measurement data from the motion sensor. If the determination at 360 is positive (e.g., YES), the determination can return to 350. If the determination is negative (e.g., NO), the method 300 can proceed to 370. At 370, user input can be received that indicates that the wireless beacon is located at a desired location. At 380, the beacon control can enable the broadcasting of the profile data. At 390, a user of a mobile device can employ the mobile device to re-provision the wireless beacon for the desired location and the method 300 can return to 320.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A wireless beacon being configured to:
operate in a stationary mode of operation, wherein profile data that uniquely identifies the wireless beacon is broadcast in the stationary mode of operation;
detect that the wireless beacon has moved by a threshold displacement setting; and
switch to a moving mode of operation in response to the detecting.

2. The wireless beacon of claim 1, wherein the wireless beacon comprises a Bluetooth low energy (BLE) beacon.

3. The wireless beacon of claim 1, wherein the beacon comprises a Bluetooth beacon.

4. The wireless beacon of claim 1, wherein the beacon comprises a WiFi beacon.

5. The wireless beacon of claim 1, wherein the beacon is further configured to cease the broadcasting of the profile data in the moving mode of operation.

6. The wireless beacon of claim 1, wherein the beacon is further configured to change the profile data in the moving mode of operation.

7. The wireless beacon of claim 6, wherein the profile data is changed periodically in the moving mode of operation.

8. The wireless beacon of claim 7, wherein the wireless beacon is further configured to detect that the wireless beacon has ceased moving in the moving mode of operation.

9. The wireless beacon of claim 8, wherein the wireless beacon is further configured cease the changing of the profile data and switch from the moving mode of operation to the stationary mode of operation in response to detecting that the wireless beacon has ceased moving.

10. The wireless beacon of claim 1, wherein the wireless beacon is further configured to change a proper subset of the profile data in the moving mode of operation.

11. The wireless beacon of claim 10, wherein the profile data comprises:
a universally unique identifier (UUID);
a major code; and
a minor code, wherein changing the profile data includes changing the minor code.

12. A wireless beacon comprising:
a motion sensor configured to detect movement of the wireless beacon;
a memory configured to store machine readable instructions; and
a processing unit configured to access the memory and execute the machine readable instructions, the machine readable instructions comprising:
a beacon control configured to:
access profile data stored in the memory;
receive data from the motion sensor that characterizes the detected movements of the wireless beacon; and
control broadcasting of a radio frequency (RF) signal that includes the profile data based on the data received from the motion sensor.

13. The wireless beacon of claim 12, wherein the controlling of the broadcasting of the RF signal is also based on beacon settings stored in the memory.

14. The wireless beacon of claim 13, wherein the beacon settings are based on user input.

15. The wireless beacon of claim 12, wherein the motion sensor comprises an accelerometer.

16. The wireless beacon of claim 12, wherein the controlling of the broadcasting further comprises ceasing the broadcasting in response to determining that the wireless device has moved a predetermined distance.

17. The wireless beacon of claim 12, wherein the controlling of the broadcasting further comprises changing the profile data in response to determining that the wireless device has moved a predetermined distance.

18. The wireless beacon of claim 17, wherein the controlling of the broadcasting further comprises ceasing the changing of the profile data in response to determining that the wireless device has stopped moving.

19. A method comprising:
broadcasting, by a wireless beacon, profile data that uniquely identifies the wireless beacon; and
detecting, at the wireless beacon, that the wireless beacon is moving.

20. The method of claim 19, further comprising ceasing the broadcasting in response to the detecting that the wireless beacon is moving.

21. The method of claim 19, further comprising enabling the broadcasting in response to the detecting that the wireless beacon has stopped moving.

22. The method of claim 21, further comprising provisioning the wireless beacon at a desired location after the wireless beacon has stopped moving.

23. The method of claim 19, further comprising changing the profile data in response to the detecting that the wireless beacon is moving.

24. The method of claim 23, further comprising ceasing the changing of the profile data in response to the detecting that the wireless beacon has stopped moving.

25. The method of claim 24, further comprising provisioning the wireless beacon at a desired location after the wireless beacon has stopped moving.
